(19) United States
(12) Patent Application Publication
(10) Pub. No.: US 2026/0370413 A1
(43) Pub. Date: Nov. 19, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP)

(73) Assignee: NTT DOCOMO, INC., Tokyo (JP)

(21) Appl. No.: 19/154,824

(22) PCT Filed: Feb. 17, 2023
(86) PCT No.: PCT/JP2023/005739

§ 371 Date: Aug. 8, 2025

(51) Int. Cl. H04L 5/00; H04W 72/1268

(52) U.S. Cl. CPC H04L 5/0051; H04W 72/1268

(57) ABSTRACT

A terminal according to one aspect of the present disclosure includes a receiving section that receives information related to a type of a demodulation reference signal (DMRS) for a physical uplink shared channel (PUSCH), and a control section that controls to apply a specific DMRS type when dynamic waveform switching for the PUSCH is configured.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1:3GPP TS 36.300 V 8.12.0 “Evolved Universal Terrestrial Radio Access (E-UTRA) and Evolved Universal Terrestrial Radio Access Network (E-UTRAN); Overall description; Stage 2 (Release 8),” April, 2010

### Summary of Invention

### Technical Problem

For future wireless communication systems, it has been studied to support a cyclic prefix-orthogonal frequency division multiplexing (CP-OFDM) waveform, which is a multicarrier waveform, in addition to a discrete Fourier transform-spread-orthogonal frequency division multiplexing (DFT-s-OFDM) waveform, which is a single-carrier waveform.

However, a conventional waveform configuration is performed by Radio Resource Control (RRC), and thus reconfiguration of RRC is required to switch a waveform. Therefore, signaling overhead may increase, and communication throughput may be reduced.

Thus, an object of the present disclosure is to provide a terminal, a radio communication method, and a base station that can appropriately perform waveform switching.

### Solution to Problem

A terminal according to one aspect of the present disclosure includes a receiving section that receives information related to a type of a demodulation reference signal (DMRS) for a physical uplink shared channel (PUSCH), and a control section that controls to apply a specific DMRS type when dynamic waveform switching for the PUSCH is configured.

### Advantageous Effects of Invention

According to one aspect of the present disclosure, it is possible to appropriately perform waveform switching.

### BRIEF DESCRIPTION OF DRAWINGS

FIG. 1 is a diagram to show a DCI size of Option 1-1.

FIG. 2 is a diagram to show a DCI size of Option 1-2.

FIG. 3 is a flowchart to show an example of processing according to Embodiment 0.1.

FIG. 4 is a flowchart to show an example of processing according to Embodiment 0.2.

FIG. 5 is a diagram to show a definition of PTRS-DMRS association and DMRS sequence initialization of a DCI field.

FIG. 6 is a diagram to show an example of a configuration pattern of useInterlacePUCCH-PUSCH, resourceAllocation, and RA type.

FIG. 7 is a flowchart to show an example of processing according to Embodiment 3.

FIG. 8 is a diagram to show an example of a MAC payload.

FIG. 9 is a diagram to show an example of the number of fields of an RAR grand field.

FIG. 10 is a diagram to show an example of a value of a TPC command.

FIG. 11 is a diagram to show an example of Backoff Parameter value.

FIG. 12 is a diagram to show an example of an antenna port field of DCI format 0_1.

FIG. 13 is a diagram to show an example of configuration of DMRS type when dynamic waveform switching is configured.

FIG. 14 FIG. 14A and FIG. 14B are diagrams to show examples of a method of interpreting a codepoint of a given field of DCI when dynamic waveform switching is configured and DMRS type 2 is configured.

FIG. 15 is a diagram to show an example of a schematic structure of a radio communication system according to one embodiment.

FIG. 16 is a diagram to show an example of a structure of a base station according to one embodiment.

FIG. 17 is a diagram to show an example of a structure of a user terminal according to one embodiment.

FIG. 18 is a diagram to show an example of a hardware structure of the base station and the user terminal according to one embodiment.

FIG. 19 is a diagram to show an example of a vehicle according to one embodiment.

### DESCRIPTION OF EMBODIMENTS

### CP-OFDM and DFT-s-OFDM

In an uplink (UL) of a radio communication system (for example, NR), in addition to a Cyclic Prefix-Orthogonal Frequency Division Multiplexing (CP-OFDM) waveform that is a multicarrier waveform, a Discrete Fourier Transform-Spread-Orthogonal Frequency Division Multiplexing (DFT-s-OFDM) waveform that is a single carrier waveform is supported. The “waveform” in the present disclosure indicates at least one of a CP-OFDM waveform (CP-OFDM-based waveform) and a DFT-s-OFDM waveform (DFT-s-OFDM-based waveform).

In CP-OFDM, frequency resource allocation may be more flexibly performed. For example, both continuous Physical Resource Block (PRB) allocation and discontinuous PRB allocation are allowed. The continuous PRB allocation is not limited to multiples of 2, 3, and 5. When CP-OFDM is employed, frequency division multiplexing (FDM) may be used for a DeModulation reference signal (DMRS) and a PUSCH.

DET-s-OFDM (or DFT-s-OFDM/DFTS-OFDM) has a large restriction on frequency resource allocation, but has a low peak to average power ratio (PAPR) and is suitable for a power-limited UE.

Note that, as for communication throughput without consideration of the PAPR, the communication throughput of CP-OFDM is higher than that of DFT-s-OFDM. Regarding the communication throughput in consideration of PAPP, in a case of high SNR (MCS) (a modulation and coding scheme is 16QAM or 64QAM), the communication throughput of CP-OFDM is higher than that of DFT-s-OFDM, but in a case of low SNR (MCS) (the modulation and coding scheme is QPSK), the communication throughput of DFT-s-OFDM is higher than that of CP-OFDM. In other words, a preferable waveform varies depending on the SNR (MCS).

Normally, a network (NW) switches a waveform, based on a Signal to Noise Ratio (SNR). Switching between DFT-s-OFDM and CP-OFDM is performed by a transform precoder “transformPrecoder” of an uplink shared channel (Physical Uplink Shared Channel (PUSCH) configuration (PUSCH-Config)) of Radio Resource Control (RRC) signaling. When the transform precoder is disabled, CP-OFDM is applied, and when the transform precoder is enabled, DET-s-OFDM is applied. Switching of a waveform requires RRC reconfiguration. This may increase signaling overhead and reduce communication throughput.

For more flexible throughput control, it is conceivable to dynamically switch between CP-OFDM and DFT-s-OFDM by DCI/MAC CE. However, such dynamic switching has not been studied yet.

For example, in existing specifications (for example, 3GPP Rel. 16), as shown in the following (1) to (6), sizes of some DCI fields of DCI formats (for example, DCI formats 0_0/0_1/0_2) are affected from waveform switching.
(1) In a “Precoding information and number of layers” field, different tables are used for two waveforms.
(2) In an “Antenna ports” field, different tables are used for two waveforms.
(3) In a “DMRS sequence initialization” field, the field is 0 bit when a transform precoder is enabled, and the field is 1 bit when the transform precoder is disabled.
(4) In a “PTRS-DMRS association” field, a DCI size is affected from the transform precoder.
(5) In a “frequency domain resource assignment”, the DCI size varies depending on a resource allocation type. The resource allocation to be supported varies depending on a waveform. CP-OFDM supports resource allocation types 0, 1, 2, and DET-s-OFDM supports resource allocation types 1 and 2.
(6) In a “Frequency hopping flag” field, the DCI size varies depending on the resource allocation type. As described above, the resource allocation to be supported varies depending on the waveform.

### Dynamic Switching Between Disabling and Enabling of Transform Precoder

The UE may receive a configuration indicating that the transform precoder for the PUSCH is dynamically switched between disabled and enabled by DCI/MAC CE. Then, the UE may receive an indication indicating enabling or disabling of the transform precoder for the PUSCH through DCI/MAC CE. Hereinafter, the dynamic switching by DCI/MAC CE may be simply referred to as dynamic switching. Note that the UE may be configured in advance to dynamically switch a waveform/transform precoder (to be able to switch the waveform/transform precoder) by higher layer signaling or the like. Regardless of presence or absence of the configuration, the dynamic switching of the transform precoder by DCI/MAC CE may be possible.

For example, DCI signaling-based dynamic waveform switching may be performed implicitly or explicitly. For example, a 1-bit field may be included in DCI, the field indicating a CP-OFDM or DFT-s-OFDM waveform used for the PUSCH (explicit signaling). For example, the UE may determine/identify the CP-OFDM or DFT-s-OFDM waveform used for the PUSCH according to a specific condition among the scheduling information in DCI or the like (implicit signaling). In this case, an existing DCI format is not changed.

Alternatively, dynamic UL waveform switching based on MAC CE signaling may be performed. For example, a 1-bit field may be included in a MAC CE, the field indicating a CP-OFDM or DFT-s-OFDM waveform used for the PUSCH (explicit signaling). Alternatively, the UE may determine/identify the CP-OFDM or DFT-s-OFDM waveform used for the PUSCH, based on an existing field of the MAC CE (implicit signaling).

The DCI format in the present disclosure may indicate, for example, DCI format 0_0/0_1/0_2, or may be another format (for example, DCI format 0_3 for reporting waveform switching). As another format, for example, group common DCI such as DCI format 2_x may be used. In this case, the waveform switching may be applied after a certain time from when the UE receives DCI format 2_x and transmits ACK.

The switching between disabling and enabling of the transform precoder (switching of the waveform) in the present disclosure may be waveform switching in the same BWP (switching of the waveform without switching the BWP). For example, since a different transform precoder can be configured for each BWP, it is conceivable to switch the transform precoder by switching the BWP. However, switching between disabling and enabling the transform precoder in the same BWP allows to suppress the delay.

When the dynamic switching between disabling and enabling of the transform precoder for the PUSCH is configured by DCI/MAC CE, the UE may receive an indication that indicates enabling or disabling of the transform precoder for the PUSCH by the DCI/MAC CE, and switch the waveform (CP-OFDM/DFT-s-OFDM) to use for the PUSCH, based on the indication.

The total DCI size of a DCI format may be constant regardless of the disabling and enabling of the transform precoder. The size of the DCI format may be configured/determined by higher layer signaling (RRC). In other words, the size of the DCI format may not depend on DCI/MAC CE.

However, in a part of DCI fields, the sizes of respective DCI fields may be different from each other depending on whether the transform precoder is disabled or enabled. The part of DCI fields is, for example,“Precoding information and number of layers.” “Antenna ports,” “DMRS sequence initialization,” “PTRS-DMRS association,” “Frequency resource allocation,” “Frequency hopping flag.” For example, as shown in (1) to (6) of the above-described existing specifications, the DCI size may be different from each other.

### {Option 1-1}

When the dynamic switching of the transform precoder for the PUSCH (switching by DCI/MAC CE) is configured for the PUSCH, for each DCI format, the total size of the DCI format may be the larger one of the size of each DCI format when the transform precoder is disabled and the size of each DCI format when the transform precoder is enabled.

When the transform precoder is disabled/enabled by the MAC CE, the UE may read each DCI field from the least significant bit (LSB), depending on the size of each DCI field. Alternatively, the UE may read each DCI field from the most significant bit (MSB).

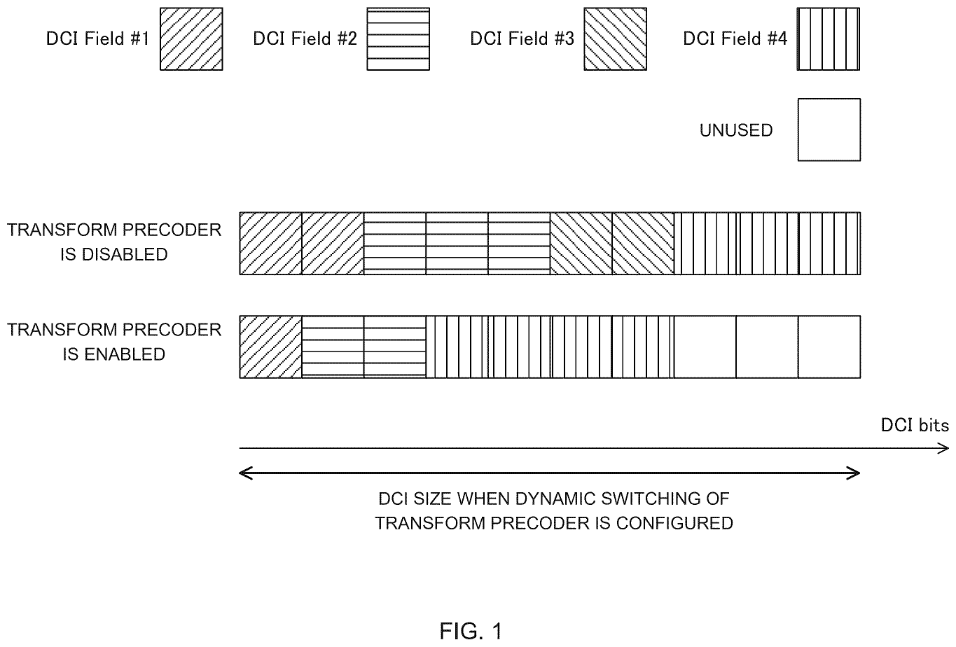

FIG. 1 is a diagram to show the DCI size of Option 1-1. According to FIG. 1, the number of DCI bits (the total of DCIField #1 to #4) when the transform precoder is disabled is 10 bits, and the number of DCI bits when the transform precoder is enabled is 7 bits. In this case, 10 bits, which is the larger DCI size, is used as the total DCI size when the dynamic switching of the transform precoder is configured.

In FIG. 1, the smaller DCI bits (DCI bits when the transform precoder is enabled) are mapped from the left side (least significant bit), but may be mapped from the right side (most significant bit). In other words, the UE may read each DCI field from the least significant bit, or may read each DCI field from the most significant bit.

In Option 1-1,the total size of DCI can be reduced as compared with Option 1-2 described below.

### {Option 1-2}

When the dynamic switching of the transform precoder for the PUSCH is configured for the PUSCH, for each DCI format, a larger size of the size of the DCI field when the transform precoder is disabled and the size of the DCI field when the transform precoder is enabled may be determined for each field, and the total size of the DCI format may be a total value of the larger sizes in all the DCI fields.

In other words, when the number of fields of a given DCI format is N, the total size of the DCI format is calculated as follows.

Total size of DCI format=>(MAX (size of DCI field i when the transform precoder is disabled, size of DCI field I when the transform precoder is enabled)) (i=1 to N).

When the transform precoder is disabled/enabled by the MAC CE, the UE may read each DCI field from the least significant bit (LSB), depending on the size of each DCI field. Alternatively, the UE may read each DCI field from the most significant bit (MSB).

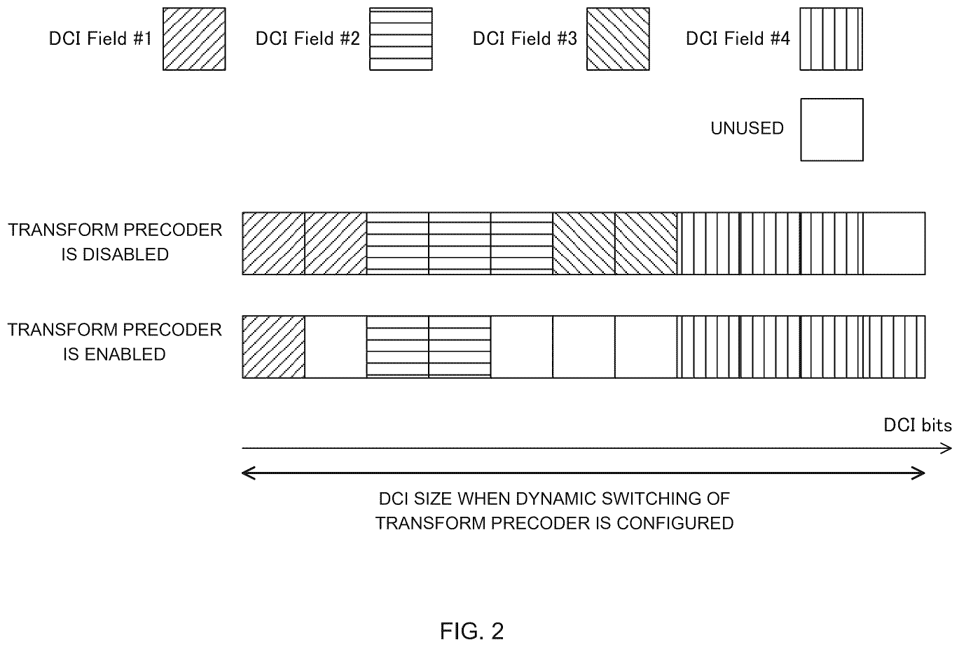

FIG. 2 is a diagram to show the DCI size of Option 1-1.

According to FIG. 2, in DCI Field #1, a larger size of the size (2 bits) of the DCI field when the transform precoder is disabled and the size (1 bit) of the DCI field when the transform precoder is enabled is 2 bits. Similarly, the larger size is 3 bits for DCI Field #2, 2 bits for DCI Field #3, and 4 bits for DCI Field #4.

By summing these sizes (2+3+2+4=11), 11 bits are used as the total DCI size when dynamic switching of the transform precoder is configured.

In FIG. 2, the smaller DCI bits are mapped from the left side (least significant bit) in each field, but may be mapped from the right side (most significant bit). In other words, the UE may read each DCI field from the least significant bit, or may read each DCI field from the most significant bit.

In the example of FIG. 2, bits at the start position of each field (a bit range used for each field) are the same between a case in which the transform precoder is disabled and a case in which the transform precoder is enabled. For example, the start position of the DCI Field #1 is the first bit, the start position of the DCI Field #2 is the third bit, the start position of the DCI Field #3 is the sixth bit, and the start position of the DCI Field #4 is the eighth bit. Therefore, detection processing of each field by the UE can be simplified.

In Option 1-2,even if the transform precoder is switched between enabled and disabled, the sizes of DCI to detect are the same, allowing to suppress an increase in processing load of the UE.

### FDRA Type

In NR, three types of following type 0, type 1,and type 2 are supported as frequency domain resource allocation (FDRA) types.
Type 0: Bitmap-based allocation (i.e., this may be discontinuous).
Type 1: Continuous allocation based on a resource indication value (RIV).
Type 2: Interlaced arrangement (for NR−).

Applicability depending on each type of PUSCH waveform is supported as follows.

Type 0: only CP-OFDM is applicable.

Type 1: Applicable to both CP-OFDM and DETS-OFDM.

Type 2: Applicable to both CP-OFDM and DETS-OFDM.

When an RRC parameter useInterlacePUCCH-PUSCH is not configured, type 0 or type 1 is used depending on an RRC parameter resourceAllocation. When type-1 UL data is transmitted without a grant, resourceAllocation is configured to resourceAllocationType0 or resourceAllocationType1. When resourceAllocationType0 is configured, type 0 is used, and when resourceAllocationType1 is configured, type 1 is used. When dynamicSwitch is configured, type 0 or type 1 is indicated by scheduling DCI (MSB of FDRA). When useInterlacePUCCH-PUSCH is configured, type 2 is used.

### Analysis

A conventional waveform configuration is performed by Radio Resource Control (RRC), and thus reconfiguration of RRC is required to switch a waveform. This may increase signaling overhead and reduce communication throughput. Therefore, as described above, by performing the dynamic switching of the transform precoder for the PUSCH (switching by DCI/MAC CE), switching of the waveform can be easily (quickly) performed.

However, in this case, as shown in the following issues 0 to 4, some of various configurations/controls are unclear.

Therefore, the present inventors have come up with an idea of a terminal that appropriately dynamically switches between disabling and enabling (switching of waveforms) of the transform precoder for the PUSCH.

Embodiments according to the present disclosure will be described in detail with reference to the drawings as follows.

The radio communication methods according to respective embodiments may each be employed individually, or may be employed in combination.

In the present disclosure,“A/B” and “at least one of A and B” may be interchangeably interpreted. In the present disclosure, “A/B/C” may mean “at least one of A, B, and C.” In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, application/use of CP-OFDM and the transform precoder (transformPrecoder) being disabled (disabling) may be interchangeably interpreted. Application/use of DFT-s-OFDM and the transform precoder being enabled (enabling) may be interchangeably interpreted. Disabling/enabling of the transform precoder, switching of the transform precoder, and switching of the waveform (CP-OFDM/DFT-s-OFDM) may be interchangeably interpreted. A PUSCH waveform, a waveform, and a transform precoder may be interchangeably interpreted. CP-OFDM and a CP-OFDM waveform may be interchangeably interpreted. DFT-s-OFDM and a DFT-s-OFDM waveform may be interchangeably interpreted. “Enabled” and “on” may be interchangeably interpreted. “Disabled” and “off” may be interchangeably interpreted. A “case in which a PUSCH waveform can be dynamically switched” and a “case in which dynamic switching of a PUSCH waveform is configured” may be interchangeably interpreted.

### Radio Communication Method

As described above, the UE may receive a configuration indicating that the transform precoder for the PUSCH is dynamically switched between disabled and enabled by DCI/MAC CE. Then, the UE may receive an indication indicating enabling or disabling of the transform precoder for the PUSCH through DCI/MAC CE. In other words, the UE can dynamically switch the PUSCH waveform. In this case, at least one of processes of the following embodiments may be applied.

In the present disclosure, when the PUSCH waveform can be dynamically switched, at least one method in the above-described (dynamic switching between disabling and enabling of the transform precoder) may be applied.

### <Issue 0>

When a PUSCH waveform can be dynamically switched, it is not clear what values are configured for RRC parameters, transformPrecoder and maxRank. For example, transformPrecoder is expected to have a value corresponding to any one of enabled (i.e., DFT-s-OFDM), disabled (i.e., CP-OFDM), and no limitation. For example, configuration of the RRC parameter transformPrecoder affects the DCI size and processing load of and communication overhead of the UE, and thus it is preferable to clarify this point.

### Embodiment 0.1

When the UE can dynamically switch a PUSCH waveform, the configuration of any of the following aspects may be applied to an RRC parameter transform precoder (transformPrecoder).

### {Aspect 1}

When the PUSCH waveform can be dynamically switched, the RRC parameter transformPrecoder may be configured to be enabled. This reduces the DCI size assumed by the UE. In other words, the NW (base station, gNB) can configure the DCI size to be small, and therefore, can suppress communication overhead.

### {Aspect 2}

When the PUSCH waveform can be dynamically switched, the RRC parameter transformPrecoder may be configured to disabled. By this means, even when the PUSCH waveform is switched to DFT-s-OFDM, the UE assumes the same DCI size as in CP-OFDM, so that it is possible to reduce processing load of the UE.

### {Aspect 3}

When the PUSCH waveform can be dynamically switched, the RRC parameter transformPrecoder may be ignored. In other words, transformPrecoder may not be limited.

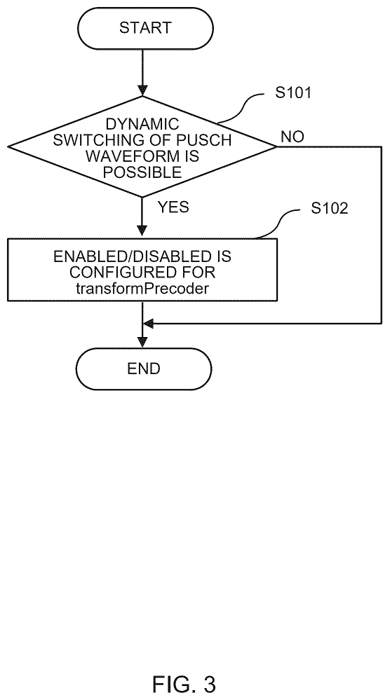

FIG. 3 is a flowchart to show an example of processing according to Embodiment 0.1. When the UE receives a configuration indicating that the PUSCH waveform can be dynamically switched (step S101), the UE receives the RRC parameter transformPrecoder in which enabled/disabled is configured (step S102).

As the RRC parameter, a plurality pieces of transformPrecoder exist, but the transformPrecoder referred to by the UE may varies for each case (each timing). For example, the following Options 1 and 2 may be applied. The processing of the following Options 1 and 2 may be applied at a timing before the dynamic switching indication for the PUSCH waveform when the dynamic switching of the PUSCH waveform is configured.

### Option 1

The UE may refer to/consider transformPrecoder in an RRC IE (e.g., PUSCH-Config or ConfiguredGrantConfig) corresponding to the PUSCH to transmit. This option may be applied to the UE after dedicated (UE-specific) RRC configuration.

### Option 2

The UE may refer to/consider transformPrecoder in a specific RRC IE regardless of the type of PUSCH (e.g., msg3-transformPrecoder of RACH-ConfigCommon, or the like). This option may be applied to the UE before dedicated (UE-specific) RRC configuration.

According to the present embodiment, it is possible to clarify a value to be configured and actions of the UE for the RRC parameter transformPrecoder in a case that the PUSCH waveform can be dynamically switched.

### Embodiment 0.2

When the UE can dynamically switch the PUSCH waveforms, the UE may receive a value/configuration based on any of the following aspects/options, as the maximum rank (maxRank) of the RRC parameter. In other words, the UE may assume application of any of the following aspects/options for the value/configuration of maxRank. maxRank is a parameter indicating the maximum value of a transmission rank (layer) of UL (PUSCH). The UE controls transmission of the PUSCH, based on maxRank.

### {Aspect 1}

There may be no limitation on a configuration of maxRank. In other words, even when dynamic switching of the PUSCH waveform is configured, an arbitrary value may be configured for maxRank.

### {Aspect 2}

A specific value or a value smaller than the specific value may be configured for maxRank. The specific value may be determined (fixed) by specifications, for example. Alternatively, the specific value may be configured/indicated by RRC/MAC CE/DCI. For example, when dynamic switching of the PUSCH waveform is configured, maxRank (specific value) may be 1.

When maxRank is limited, for example, when only 1 can be configured for maxRank, bit widths of Transmitted Precoding Matrix Indicator (TPMI) are the same regardless of the waveform of the PUSCH. In other words, since the DCI size is the same, it is possible to reduce processing load of the UE.

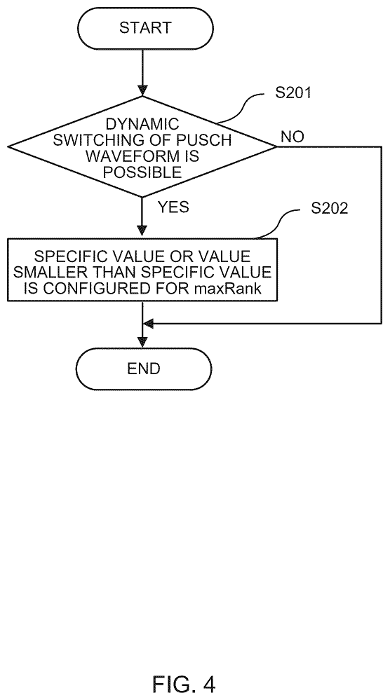

FIG. 4 is a flowchart to show an example of processing according to Embodiment 0.2. FIG. 4 shows an example of above-described aspect 2. When the UE receives a configuration indicating that the PUSCH waveform can be dynamically switched (step S201), the UE receives a configuration indicating a specific value or a value smaller than the specific value as a value of an RRC parameter maxRank (step S202).

According to the present embodiment, it is possible to clarify a value to be configured for the RRC parameter maxRank in a case that the PUSCH waveform can be dynamically switched.

### <Issue 1>

When the PUSCH waveform can be dynamically switched, how to handle a DCI field that may exist (one or more bits) or may not exist (0 bit) depending on the waveform of the PUSCH is not clear. The DCI field is, for example, PTRS-DMRS association and DMRS sequence initialization.

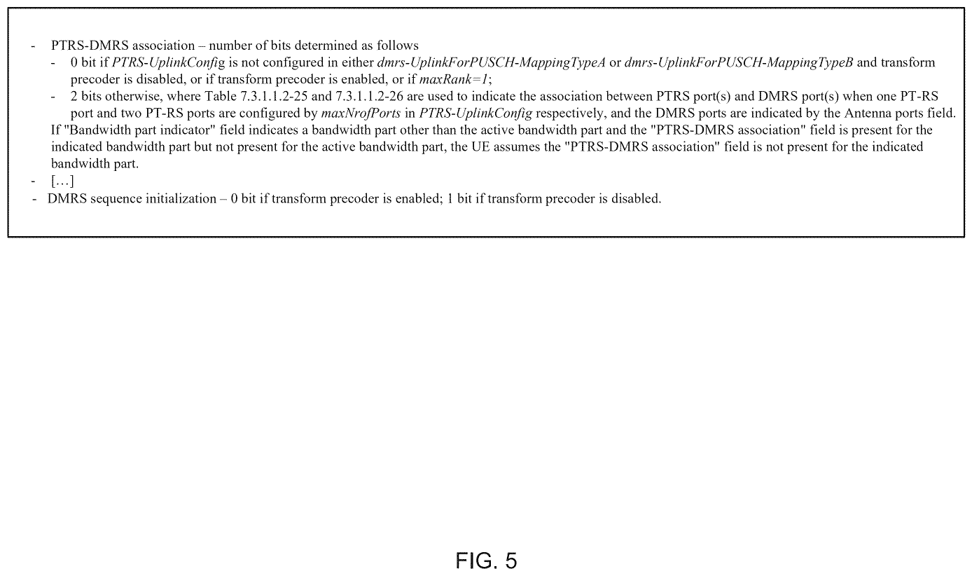

FIG. 5 is a diagram to show a definition of PTRS-DMRS association and DMRS sequence initialization of a DCI field. As shown in FIG. 5, DMRS sequence initialization is 0 bit when CP-OFDM is applied (transform precoder is disabled) without PTRS (PTRS UplinkConfig) being configured, when DETS-OFDM is applied (if transform precoder is enabled), or when maxRank =1, and is 2 bits otherwise. The DMRS sequence initialization is 0 bit when DFTS-OFDM is applied and is 1 bit when CP-OFDM is applied.

### First Embodiment

When the PUSCH waveform can be dynamically switched and a specific waveform is indicated for the PUSCH, the UE may process (assume) a specific field of scheduling DCI of the PUSCH, based on a specific rule.

The specific field of the DCI may be at least one of a demodulation reference signal (DMRS) sequence initialization field and a phase tracking reference signal (PTRS)-DMRS association field.

The specific rule may be that the UE ignores a specific field of the DCI.

The specific waveform may be DET-s-OFDM or CP-OFDM.

For example, when the UE receives DCI, a PUSCH waveform can be dynamically switched, and DFT-s-OFDM is indicated for the PUSCH, the UE ignores at least one of a DMRS sequence initialization field and a PTRS-DMRS association field of the DCI.

Without being limited to the above examples, when the DMRS sequence initialization field or the PTRS-DMRS association field of FIG. 5 satisfies a condition of 0 bit, the UE may ignore the field. This can reduce the processing load of the UE.

In a first embodiment, when the PUSCH waveform is dynamically switched, the number of bits per DCI field/the total DCI size may follow the rule for CP-OFDM, regardless of an exact waveform used by the UE. Alternatively, the number of bits of each DCI field/the total DCI size may not follow the rule for CP-OFDM.

### <Issue 2>

As described in the above (FDRA type), since the RA of type 0 cannot be used for DFT-s-OFDM, when the PUSCH waveform is switched to DFT-s-OFDM, it is necessary to use type 1 or type 2. For example, an RRC parameter indicating the PUSCH waveform preferably always supports a configuration/indication of an FDRA type.

However, when the PUSCH waveform is dynamically switched, a configuration of the FDRA or interlace usage indication (useInterlacePUCCH-PUSCH) is not clear.

### Second Embodiment

When the PUSCH waveform can be dynamically switched and a specific waveform is indicated for the PUSCH, the UE may receive a specific field of DCI and a specific RRC parameter, corresponding to the scheduling of the PUSCH based on a specific rule (may assume reception of the specific field of DCI and the specific RRC parameter). The UE may control a PUSCH transmission based on a given field of received DCI and a certain RRC parameter.

A specific field of DCI may be an FDRA or a frequency hopping flag.

The specific RRC parameter may be a resource allocation (resourceAllocation) or an interlaced usage indication of PUCCH and PUSCH (useInterlacePUCCH-PUSCH).

The specific waveform may be DFT-s-OFDM or CP-OFDM.

A specific rule may be that resourceAllocation is either resourceAllcationType1 or dynamicSwitch. When resourceAllocation is dynamicSwitch, the most significant bit (MSB) of the FDRA is required to be “1.” In other words, type 1 of FDRA is required to be indicated. This specific rule may be applied when useInterlacePUCCH-PUSCH is not configured.

The specific rule may be that resourceAllocation is resourceAllcationType1.

The specific rule may be that the frequency-hopping flag is determined according to at least one of resourceAllocation and FDRA based on the specific rule.

The specific rule may be that useInterlacePUCCH-PUSCH (use of interlace for PUCCH and PUSCH) is configured to be enabled (use of interlace for PUCCH and PUSCH).

### Concrete Examples

For example, when the PUSCH waveform can be dynamically switched and DFT-s-OFDM is indicated for the PUSCH, the UE may receive (may assume reception of) configuration information (RRC parameter) indicating dynamic switching (dynamicSwitch) as resourceAllocation and indication information (DCI) indicating type 1 as the FDRA. The UE may control PUSCH transmission, based on the configuration information and the indication information.

For example, when the PUSCH waveform can be dynamically switched and DFT-s-OFDM is indicated for the PUSCH, the UE may receive (may assume reception of) the configuration information (RRC parameter) indicating type 1 (resourceAllcationType1) as resourceAllocation. The UE may control PUSCH transmission, based on the configuration information.

For example, when the PUSCH waveform can be dynamically switched and DFT-s-OFDM is indicated for the PUSCH, the UE may receive (may assume reception of) configuration information indicating that useInterlacePUCCH-PUSCH (use of interlace for PUCCH and PUSCH) is enabled. The UE may control PUSCH transmission, based on the configuration information.

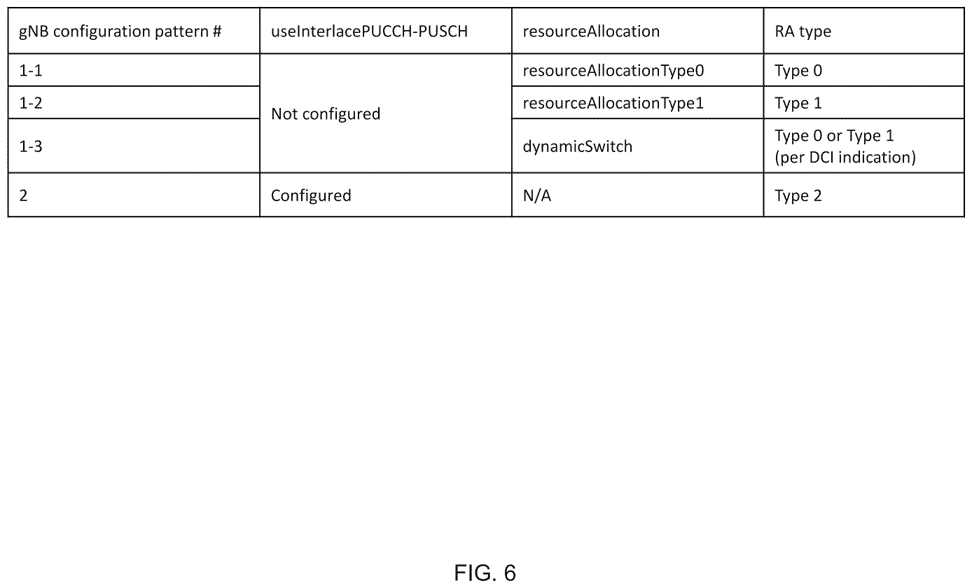

FIG. 6 is a diagram to show an example of a configuration pattern of useInterlacePUCCH-PUSCH, resourceAllocation, and RA type. When the dynamic waveform switching is possible, the following (1) and (2) may be applied to the configuration patterns illustrated in FIG. 6.
(1) When a default value of transformPrecoder is disabled (CP-OFDM is indicated/used), the UE can expect any pattern, but when the value is enabled (DFT-s-OFDM is indicated/used), patterns 1-1 and 1-3 may not be applicable.
(2) When the default value of transformPrecoder is enabled, the UE can expect patterns other than patterns 1-1 and 1-3 to apply DCI indicating type 0, but may expect any pattern when CP-OFDM is indicated/used.

The processing of the present embodiment may be applied regardless of the waveform indicated for the PUSCH. In other words, when the PUSCH waveform can be dynamically switched, the UE may control the specific field of DCI corresponding to scheduling of the PUSCH and the specific RRC parameter based on the specific rule.

According to the present embodiment, even when the PUSCH waveform is dynamically switched, it is possible to avoid a case in which an error occurs (for example, a case in which the FDRA of type 0 is configured when DFT-s-OFDM is applied).

### <Issue 3>

When the PUSCH waveform can be dynamically switched, applicable types of PUSCH are not clear. For example, it is not clear whether message 3 (Msg3)/message A (Msg3-TransformPrecoder/msgA-TransformPrecoder) is applicable as the PUSCH. It is not clear whether CG-PUSCH (transformPrecoder of ConfiguredGrantConfig) is applicable as the PUSCH. When dynamic switching of PUSCH waveforms is supported for these PUSCHs, it is not clear what kind of processing is performed.

### Embodiment 3

The UE may apply dynamic switching of PUSCH waveform only to a specific type of PUSCH. In other words, when the UE receives a configuration indicating that the PUSCH waveform is dynamically switched, the UE may control to dynamically switch only the specific type of PUSCH, based on the DCI/MAC CE. The specific type of PUSCH may be, for example, at least one of the following (1) to (4).
(1) DCI Grant (DG)-PUSCH (PUSCH scheduled by DCI).
(2) Configured Grant (CG) of Type 1-PUSCH (PUSCH transmission configured by higher layer signaling).
(3) CG-PUSCH of type 2 (PUSCH transmission configured by higher layer signaling and activated/deactivated by DCI).
(4) PUSCH scheduled by a random access response (RAR) (message 3 PUSCH or message A PUSCH). The RAR may be an RAR of contention based random access (CBRA) or an RAR of contention-free random access (CFRA). For example, in CFRA, the base station (gNB) knows the UE and a channel state of the UE, and thus the waveform can be adjusted appropriately.

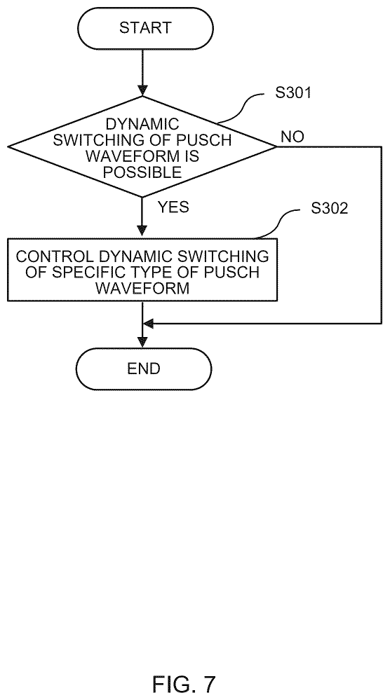

FIG. 7 is a flowchart to show an example of processing according to Embodiment 3. When the UE receives a configuration indicating that the PUSCH waveform can be dynamically switched (step S301), the UE controls to dynamically switch only the specific type of PUSCH, based on DCI/MAC CE (step S302).

### Embodiment 4.1

Dynamic switching of type 1 CG-PUSCH (PUSCH transmission configured by higher layer signaling) waveforms may be applied, and at least one of the following methods (1-1) to (1-4) may be supported. As concrete methods of (1-1) to (1-4) below, the method in the above-described (dynamic switching between disabling and enabling of the transform precoder) may be applied.
(1-1) The UE may receive an explicit indication by DCI, indicating enabled/disabled of transformPrecoder (DFT-s-OFDM/CP-OFDM) (explicit signaling).
(1-2) The UE may receive an implicit indication by DCI, indicating enabled/disabled of transformPrecoder (DFT-s-OFDM/CP-OFDM) (implicit signaling).
(1-3) The UE may receive an explicit indication by a MAC CE, indicating enabled/disabled of transformPrecoder (DFT-s-OFDM/CP-OFDM) (explicit signaling).
(1-4) The UE may receive an implicit indication by a MAC CE, indicating enabled/disabled of transformPrecoder (DFT-s-OFDM/CP-OFDM) (implicit signaling).

The methods (1-1) to (1-4) may be applied to the CG-PUSCH of type 1 separately from the PUSCH of another type (the CG-PUSCH of type 2,the DG-PUSCH). Alternatively, as the methods (1-1) to (1-4), the same method as the method of the PUSCH of another type may be applied to the CG-PUSCH of type 1.

For a conventional CG-PUSCH of type 1,DCI is not used for scheduling. Therefore, when the above (1-1) and (1-2) are applied, it is preferable to newly define DCI. For example, as the DCI of the above (1-1) and (1-2), any of the following (2-1) and (2-2) may be applied.
(2-1) DCI for scheduling unicast data of UL/DL may be applied. Note that the UL/DL-SCH actually scheduled by the DCI may not exist.
(2-2) DCI for scheduling other than unicast data may be applied. For example, this DCI may be applied when group common DCI is used.

According to the present embodiment, it is possible to clarify the processing when the dynamic switching of the CG-PUSCH waveform of type 1 is applied.

### Embodiment 4.2

Dynamic switching of type-2 CG-PUSCH (PUSCH transmission configured by higher layer signaling and activated/deactivated by DCI) waveform may be applied, and at least one of the methods (1-1) to (1-4) of Embodiment 4.1 may be supported.

The methods (1-1) to (1-4) may be applied to the CG-PUSCH of type 2 separately from the PUSCH of another type (the CG-PUSCH of type 1,the DG-PUSCH). Alternatively, as the methods (1-1) to (1-4), the same method as the method of the PUSCH of another type may be applied to the CG-PUSCH of type 2.

Since DCI for activation/deactivation is used for conventional CG-PUSCH of type 2,the DCI may be reused.

Specifically, as the DCI of the above (1-1) and (1-2), any of the following (2-1) and (2-2) may be applied.
(2-1) DCI for scheduling unicast data of UL/DL may be applied. Note that the UL/DL-SCH actually scheduled by the DCI may not exist. For example, DCI for performing activation/deactivation of the CG-PUSCH of type 2 may be applied.
(2-2) DCI for scheduling other than unicast data may be applied. For example, this DCI may be applied when group common DCI is used.

According to the present embodiment, it is possible to clarify the processing when the dynamic switching of the CG-PUSCH waveform of type 2 is applied.

### Embodiment 5

Dynamic switching of message 3/message A PUSCH (PUSCH scheduled by a random access response (RAR)) waveform may be applied, and at least one of methods (1-1) to (1-4) of Embodiment 4.1 may be supported. Alternatively, the following (1-5) may be applied.

(1-5) The UE may receive an explicit/implicit indication by RAR, indicating enabled/disabled of transformPrecoder (DFT-s-OFDM/CP-OFDM).

The methods (1-1) to (1-5) may be applied to message 3/message A PUSCH separately from PUSCHs of another types (the CG-PUSCH of type 1/type 2,the DG-PUSCH). Alternatively, as the methods (1-1) to (1-5), the same method as the method of the PUSCH of another type may be applied to a message 3/message A PUSCH.

Since DCI for activation/deactivation is used for a conventional message 3/message A PUSCH, the DCI may be reused.

Specifically, as the DCI of the above (1-1) and (1-2), any of the following (2-1) and (2-2) may be applied.
(2-1) DCI for scheduling unicast data of UL/DL may be applied. Note that the UL/DL-SCH actually scheduled by the DCI may not exist. For example, the DCI may be DCI 1_0 with a cyclic redundancy check (CRC) scrambled by an RA Radio Network Temporary Identifier (RNTI) or a message B RNTI.
(2-2) DCI for scheduling other than unicast data may be applied. For example, this DCI may be applied when group common DCI is used.

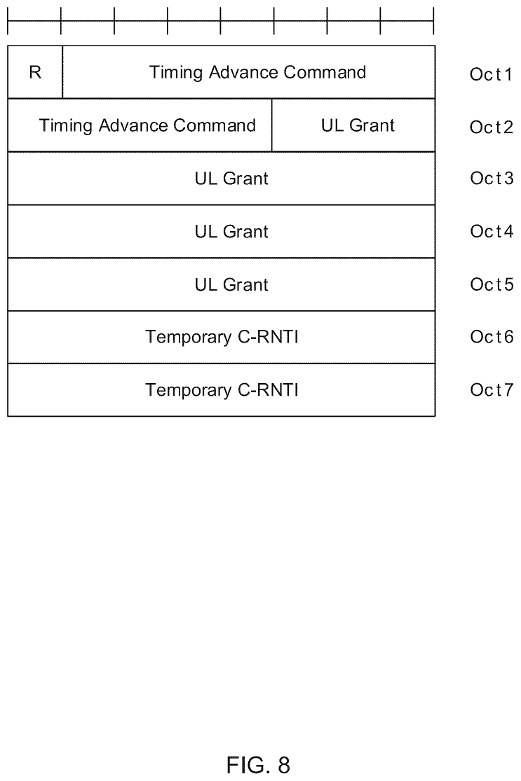

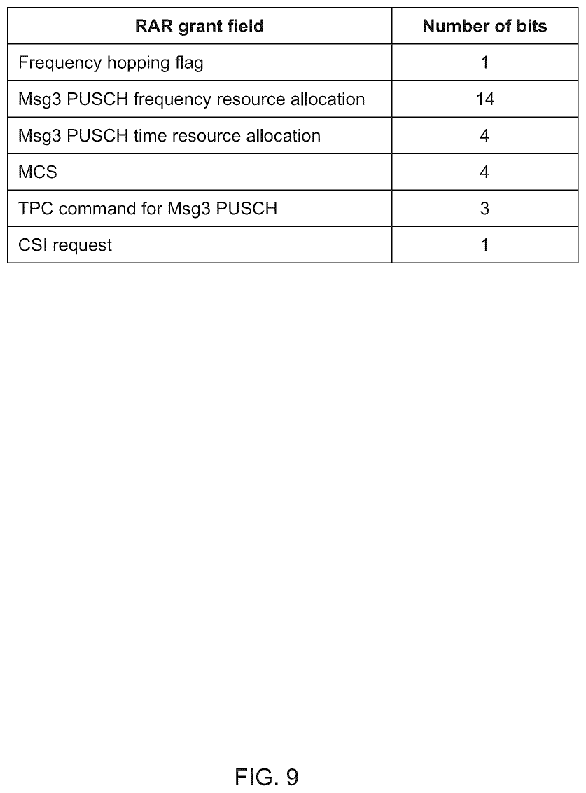

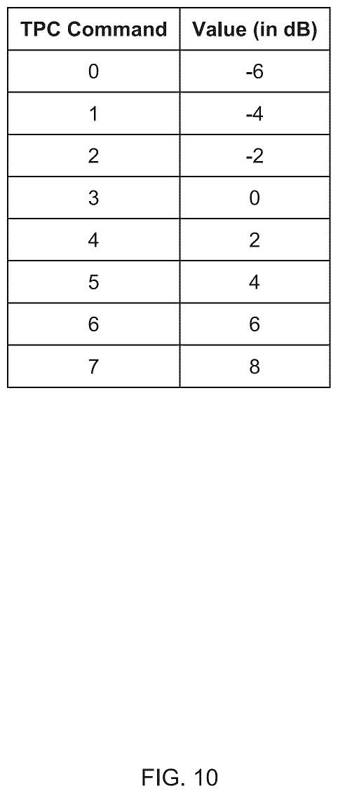

For the dynamic waveform switching of a message 3/message A PUSCH, at least one of the following (3-1) and (3-2) related to RAR-based indication may be supported. The UE may dynamically switch the waveform of message 3 PUSCH or message A PUSCH, based on at least one of a MAC subheader or a MAC payload for an RAR.
(3-1) A reserved bit (R) of the MAC subheader/MAC payload for the RAR may be released and used for dynamic waveform switching. For example,“R” in a first octet (i.e., next to Timing Advance Command) of the MAC payload shown in FIG. 8 may indicate the dynamic waveform switching.
(3-2) An RAR grant may be implicitly indicated based on an existing RAR grant field (UL Grant) shown in FIG. 9. For example, when a modulation and coding scheme (MCS) in the UL Grant indicates a specific MCS, enabled/disabled of transformPrecoder may be configured for the message 3/message A PUSCH. For example, when a value (FIGS. 9 and 10) corresponding to a TPC command for message 3 PUSCH in the UL Grant is a specific value or is larger/smaller than a specific threshold, enabled/disabled of transformPrecoder may be configured for the message 3/message A PUSCH.

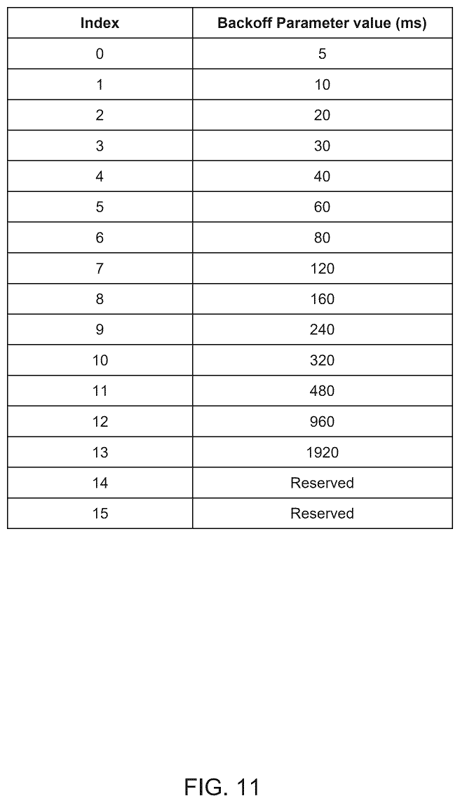

When a Backoff Parameter value (FIG. 11) corresponding to a Backoff Indicator (BI) field included in a MAC subheader for an RAR is a specific value or is greater/smaller than a specific threshold, enabled/disabled of transformPrecoder may be configured for the message 3/message A PUSCH. Alternatively, when an Extension (E) field, a Type (T) field, and a Random Access Preamble IDentifier (RAPID) field included in the MAC subheader for the RAR have specific values, enabled/disabled of transformPrecoder may be configured for the message 3/message A PUSCH.

The present embodiment may be applied when a specific condition is satisfied. The specific condition may be that a PRACH triggering the RAR is transmitted on a specific RA resource based on an RACH resource partition configuration.

According to the present embodiment, it is possible to clarify the processing in a case where dynamic switching of the message 3/message A PUSCH waveform is applied. In a case of using the RAR-based instruction for the dynamic waveform switching of the message 3/message A PUSCH, an existing MAC subheader/payload can be used, and thus an increase in communication overhead can be suppressed.

### <Issue 4>

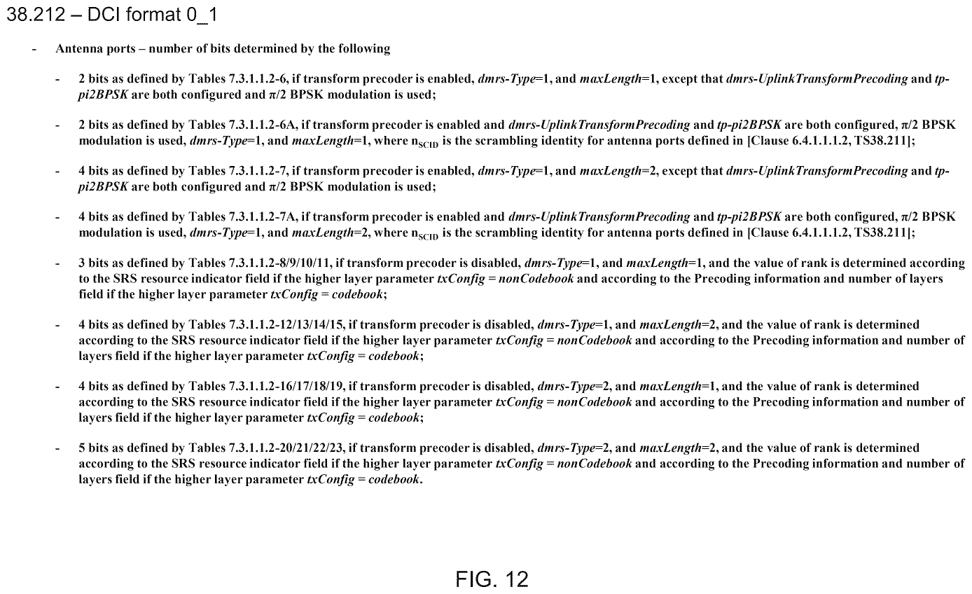

In an existing system (e.g., Rel-17 NR or earlier), in an antenna port field included in DCI format 0_1/0_2, when a transform precoder is enabled (e.g., when DFT-s-OFDM is applied to a scheduled PUSCH), DMRS type 2 (e.g., dmrs-Type=2) is not assumed (see FIG. 12). DMRS type 2 is considered/applied only when the transform precoder is disabled (e.g., when CP-OFDM is applied to a scheduled PUSCH).

When dynamic waveform switching (for example, dynamic waveform switching) is supported, switching of waveform between CP-OFDM and DFT-s-OFDM is enabled by an indication of DCI.

On the other hand, a type of PUSCH DMRS (dmrs-Type 1 or dmrs-Type 2) is configured by RRC. In this case, DMRS type 2 (or DMRS type 1) may be configured for CP-OFDM (similar to the existing system (e.g., Rel-17 NR or earlier)).

However, for DET-s-OFDM, DMRS type 2 cannot be configured in the existing system, but DMRS type 2 may be configured for DFT-s-OFDM when the dynamic waveform switching is configured/supported. This is because DCI indication (for example, waveform switching) is performed more dynamically than RRC configuration change (DMRS type configuration).

As described above, it is not clear how to configure a PUSCH DMRS type when the dynamic waveform switching is supported.

### Embodiment 6

When dynamic waveform switching (DWS) is configured, a specific DMRS type (dmrs-Type) may be applied/configured for a PUSCH DMRS.

For example, when the dynamic waveform switching is configured, the UE may control to apply the specific DMRS type (for example, DMRS type 1) regardless of a waveform (CP-OFDM or DET-s-OFDM) indicated by DCI/a DMRS type configured by RRC. This can suppress an increase in the number of combinations of {waveform, DMRS type} that the UE needs to assume in PUSCH transmission. As a result, it is possible to suppress an increase in the number of UEs that cannot be implemented.

The UE may assume/apply at least one of the following Option 6-1 to Option 6-2 for the DMRS type (dmrs-Type) of the PUSCH DMRS. In the present disclosure, a configuration of the dynamic waveform switching may be interchangeably interpreted as enabling/activating the dynamic waveform truncation.

### {Option 6-1}

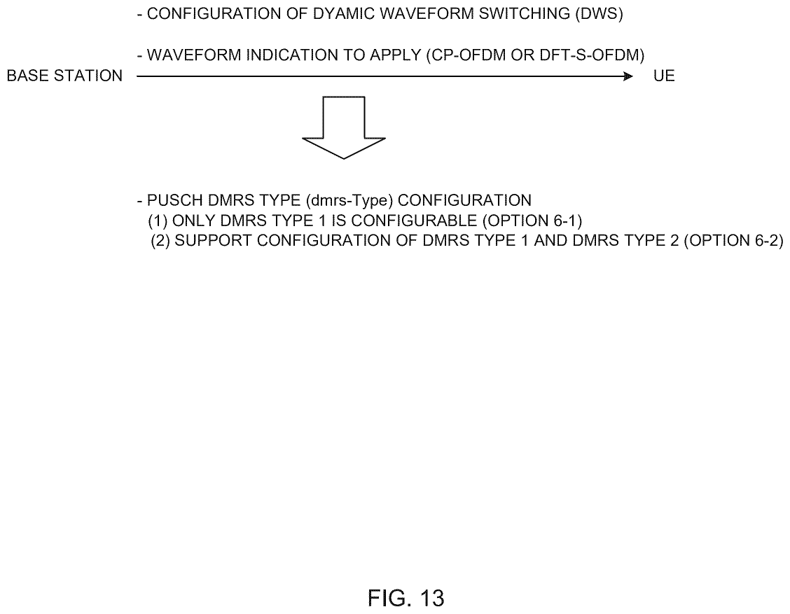

When the dynamic waveform switching is configured, only type 1 may be configured as the DMRS type (dmrs-Type) (see FIG. 13).

When the base station configures the dynamic waveform switching, the base station may control to configure for the UE only type 1 as the DMRS type of the PUSCH. In other words, when the dynamic waveform switching is configured, a configuration of DMRS type 2 by RRC may be restricted/prohibited.

In this case, DMRS type 1 may be applied regardless of a waveform (CP-OFDM or DFT-s-OFDM) indicated by DCI. When the dynamic waveform switching is configured, the UE may control to apply DMRS type 1 to both waveforms (CP-OFDM and DFT-s-OFDM).

When the dynamic waveform switching is configured, the UE may assume/expect/judge that DMRS type 1 is configured for the PUSCH DMRS.

When the dynamic waveform switching is configured, a configuration of the DMRS type of the PUSCH by the RRC may be omitted.

In this way, by configuring only a specific DMRS type, it is possible to suppress an increase in the number of combinations of {waveform, DMRS type} that the UE needs to assume in PUSCH transmission. As a result, it is possible to suppress an increase in the number of UEs that cannot be implemented.

### {Option 6-2}

When the dynamic waveform switching is configured, a configuration of DMRS type 1 and DMRS type 2 may be supported/allowed as the DMRS type (see FIG. 13).

When the base station configures the dynamic waveform switching, the base station may control to configure for the UE DMRS type 1 or DMRS type 2 as the DMRS type of the PUSCH. In other words, when the dynamic waveform switching is configured, a configuration of DMRS type 2 by RRC may be allowed.

When DMRS type 2 is configured and the dynamic waveform switching is configured, the UE may interpret that type 1 is configured as the DMRS type (for example, dmrs-Type) of the PUSCH. In other words, the UE may ignore the configuration of DMRS type 2 and apply DMRS type 1.

In this way, when the dynamic waveform switching is configured, DMRS type 1 may be applied regardless of the DMRS type configured by RRC.

In this way, by configuring the DMRS type to be applied to a specific DMRS type, it is possible to suppress an increase in the number of combinations of {waveform, DMRS type} that the UE needs to assume in PUSCH transmission. As a result, it is possible to suppress an increase in the number of UEs that cannot be implemented.

### Embodiment 7

When dynamic waveform switching (DWS) is configured, a DMRS type (dmrs-Type) to be applied based on a waveform indicated by DCI may be determined for a PUSCH DMRS.

For example, when the dynamic waveform switching is configured, the UE may determine the DMRS type to apply based on the waveform (CP-OFDM or DFT-s-OFDM) indicated by the DCI/the DMRS type configured by RRC.

When the dynamic waveform switching is configured and DFT-s-OFDM is indicated by DCI, the UE may assume/apply at least one of the following option 7-1 to option 7-2 for the DMRS type (dmrs-Type) of the PUSCH DMRS. The DCI used for indication of DFT-s-OFDM may be DCI used for scheduling of the PUSCH.

### {Option 7-1}

When the dynamic waveform switching is configured and DFT-s-OFDM is indicated by DCI, only type 1 may be applied/configured as the DMRS type.

When the base station configures the dynamic waveform switching, the base station may control to configure for the UE only type 1 as the DMRS type of the PUSCH. In other words, when the dynamic waveform switching is configured, a configuration of DMRS type 2 by RRC may be restricted/prohibited.

In this case, DMRS type 1 may be applied regardless of a waveform (CP-OFDM or DFT-s-OFDM) indicated by DCI. When the dynamic waveform switching is configured, the UE may control to apply DMRS type 1 to both waveforms (CP-OFDM and DFT-s-OFDM).

When the dynamic waveform switching is configured, the UE may assume/expect/judge that DMRS type 1 is configured for the PUSCH DMRS.

When the dynamic waveform switching is configured, a configuration of the DMRS type of the PUSCH by the RRC may be omitted.

In this way, by configuring only a specific DMRS type, it is possible to suppress an increase in the number of combinations of {waveform, DMRS type} that the UE needs to assume in PUSCH transmission. As a result, it is possible to suppress an increase in the number of UEs that cannot be implemented.

### {Option 7-2}

When the dynamic waveform switching is configured and DFT-s-OFDM is indicated by DCI, a configuration of DMRS type 1 and DMRS type 2 may be supported/allowed as the DMRS type.

When the base station configures the dynamic waveform switching, the base station may control to configure for the UE DMRS type 1 or DMRS type 2 as the DMRS type of the PUSCH. In other words, when the dynamic waveform switching is configured, a configuration of DMRS type 2 by RRC may be allowed.

When DMRS type 2 is configured, the dynamic waveform switching is configured, and DET-s-OFDM is indicated by DCI, the UE may interpret that type 1 is configured as the DMRS type (for example, dmrs-Type) of the PUSCH. In other words, when DET-s-OFDM is indicated by DCI, the UE may ignore the configuration of DMRS type 2 and apply DMRS type 1.

On the other hand, when DMRS type 2 is configured, the dynamic waveform switching is configured, and DFT-s-OFDM is not indicated by DCI (for example, when CP-OFDM is indicated), the UE may interpret that DMRS type 2 is configured as the DMRS type (for example, dmrs-Type) of the PUSCH. In other words, when DFT-s-OFDM is not indicated by DCI (for example, when CP-OFDM is indicated), the UE may apply DMRS type 2.

In this way, when the dynamic waveform switching is configured and DMRS type 2 is configured by RRC, whether or not to apply DMRS type 2 may be determined based on a waveform indicated by DCI. Note that, when the dynamic waveform switching is configured and DMRS type 1 is configured in RRC, control may be performed to apply DMRS type 1 regardless of the waveform indicated by DCI.

By this means, when CP-OFDM is indicated by DCI, DMRS type 2 can be applied, so that it is possible to flexibly control the DMRS type to apply, depending on the waveform.

### Embodiment 8

When dynamic waveform switching (DWS) is configured and DMRS type 2 is configured as a DMRS type (e. g., dmrs-Type), a given field (e.g., antenna port field) included in DCI may be interpreted based on a given rule.

When the dynamic waveform switching is configured and DMRS type 2 is configured, the UE may interpret the given field (e.g., antenna port field) included in the DCI based on the given rule.

The DCI may be DCI used for scheduling of a PUSCH. For example, at least one of the following Option 8-1 and Option 8-2 may be applied to the given rule.

### {Option 8-1}

A bit width (e.g., bitwidth) of the antenna port field is determined considering that dmrs-Type is DMRS type 2 (i.e., according to a configuration of dmrs-Type), but the UE may interpret an indication by the antenna port field by interpreting only a part of bits (or using some of the bits).

The number of the part of bits may be the same as the number of antenna port fields (or the number of bits/the number of codepoints) configured for dmrs-Type1 with type 2. In the present disclosure, the part of the bits/some of the bits may be interpreted as a part of the DCI codepoints/some of the DCI codepoints.

In this case, the determination of the bit width of the antenna port field of the DCI and the interpretation of the antenna port field may be different. In other words, the bit width/the number of codepoints of the antenna port field of the DCI may be determined based on DMRS type 2,and the antenna port field of the DCI may be interpreted on the assumption of DMRS type 1.

The number of the part of DCI codepoints may be the same as the number of antenna port fields (or the number of bits/the number of codepoints) configured for dmrs-Type1 with type 2.

Accordingly, in a case that DMRS type 2 is configured, even when DMRS type 1 is applied, the UE can appropriately interpret the antenna port field of DCI.

### {Option 8-2}

A bit width (e.g., bitwidth) of the antenna port field may be determined in consideration of dmrs-Type being DMRS type 1 (i.e., a configuration of dmrs-Type is ignored), and the UE may interpret the indication by the antenna port field in consideration of the dmrs-Type being DMRS type 1.

In this case, the determination of the bit width of the antenna port field of the DCI and the interpretation of the antenna port field may be the same. In other words, the bit width of the antenna port field of the DCI may be determined based on DMRS type 1,and the antenna port field of the DCI may be interpreted on the assumption of DMRS type 1.

Accordingly, in a case that DMRS type 2 is configured, when DMRS type 1 is applied, both the bit width and the interpretation of the antenna port field may be performed by assuming DMRS type 1. It is possible to suppress an increase in overhead of the antenna port field.

### Embodiment 9

When dynamic waveform switching (DWS) is configured, DMRS type 2 is configured as a DMRS type (e.g., dmrs-Type), and DFT-s-OFDM is indicated by DCI, a given field (e.g., antenna port field) included in DCI may be interpreted based on a given rule.

When the dynamic waveform switching is configured, DMRS type 2 is configured, and DFT-s-OFDM is indicated by the DCI, the UE may interpret the given field (e.g., antenna port field) included in the DCI based on the given rule. The DCI may be DCI used for scheduling of a PUSCH. For example, at least one of the following Option 9-1 and Option 9-2 may be applied to the given rule.

### {Option 9-1}

A bit width (e.g., bitwidth) of the antenna port field is determined considering that dmrs-Type is DMRS type 2 (i.e., according to a configuration of dmrs-Type), but the UE may interpret an indication by the antenna port field by interpreting only a part of bits (or using some of the bits).

The number of the part of bits may be the same as the number of antenna port fields (or the number of bits/the number of codepoints) configured for dmrs-Type1 with type 2. In the present disclosure, the part of the bits/some of the bits may be interpreted as a part of the DCI codepoints/some of the DCI codepoints.

In this case, the determination of the bit width of the antenna port field of the DCI and the interpretation of the antenna port field may be different. In other words, the bit width of the antenna port field of the DCI may be determined based on DMRS type 2,and the antenna port field of the DCI may be interpreted on the assumption of DMRS type 1.

The number of the part of DCI codepoints may be the same as the number of antenna port fields (or the number of bits/the number of codepoints) configured for dmrs-Type1 with type 2.

Accordingly, in a case that DMRS type 2 is configured and DFT-s-OFDM is indicated by the DCI, even when DMRS type 1 is applied, the UE can appropriately interpret the antenna port field of DCI.

Note that, when DMRS type 2 is configured and CP-OFDM is indicated by the DCI, determination of the bit width of the antenna port field of DCI and interpretation of the antenna port field may be performed based on DMRS type 2.

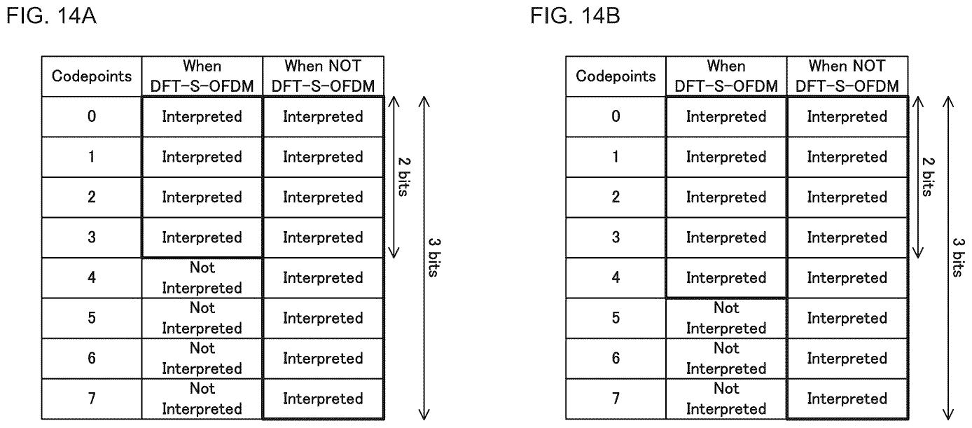

In FIGS. 14A and 14B, examples of an antenna port field of DCI when the dynamic waveform switching is configured and type 2 is configured as the DMRS type (for example, dmrs-Type) is shown.

### <<Antenna Port Field Example 1>>

When DFT-s-OFDM is indicated by the DCI for scheduling the PUSCH, the bit width (or the number of bits of the field) may be configured to 3 bits. In this case, the UE may interpret the DMRS type (e.g., dmrs-Type) as being the same as a case where type 1 is configured. For example, only two bits of the least significant bit (LSB) may be interpreted (see FIG. 14A).

When DET-s-OFDM is not indicated by the DCI for scheduling the PUSCH (e.g., when CP-OFDM is indicated), the bit width (or the number of bits of the field) may be configured to 3 bits. In this case, the UE may interpret the DMRS type (e. g., dmrs-Type) as being the same as a case where type 2 is configured. For example, all the 3 bits may be used for interpretation.

### <<Antenna Port Field Example 2>>

When DET-s-OFDM is indicated by the DCI for scheduling the PUSCH, the bit width (or the number of bits of the field) may be configured to 3 bits. In this case, the UE may interpret the 3-bit by using a given number (5 in this case) of 8 codepoints generated using 3 bits. In this case, the remaining three codepoints/fields may be used as reserved bits/reserved codepoints (see FIG. 14B).

When DFT-s-OFDM is not indicated by the DCI for scheduling the PUSCH (e. g., when CP-OFDM is indicated), the bit width (or the number of bits of the field) may be configured to 3 bits. In this case, the UE may interpret the 3 bits by using all the codepoints (here, 8 codepoints) generated with 3 bits.

In this way, when the dynamic waveform switching is configured, PUSCH DMRS transmission can be appropriately performed by flexibly controlling determination/interpretation of the bit width of the antenna port field of DCI, based on the waveform indicated by the DCI.

### {Option 9-2}

A bit width (e.g., bitwidth) of the antenna port field may be determined in consideration of dmrs-Type being DMRS type 1 (i.e., a configuration of dmrs-Type is ignored), and the UE may interpret the indication by the antenna port field in consideration of the dmrs-Type being type 1.

In this case, the determination of the bit width of the antenna port field of the DCI and the interpretation of the antenna port field may be the same. In other words, the bit width of the antenna port field of the DCI may be determined based on DMRS type 1,and the antenna port field of the DCI may be interpreted on the assumption of DMRS type 1.

Accordingly, when DMRS type 2 is configured and DFT-s-OFDM is indicated by the DCI (for example, when DMRS type 1 is applied), both the bit width and the interpretation of the antenna port field may be performed by assuming DMRS type 1. It is possible to suppress an increase in overhead of the antenna port field.

### Supplement

### {Notification of Information to UE}

Notification of any information to the UE (from the network (NW) (e. g., the base station (BS)) (in other words, reception of any information from the BS in the UE) in the above-described embodiments may be performed using physical layer signaling (e. g., DCI), higher layer signaling (e.g., RRC signaling, MAC CE), a specific signal/channel (e.g., a PDCCH, a PDSCH, a reference signal), or a combination of these.

When the notification is performed using the MAC CE, the MAC CE may be identified by including a new logical channel ID (LCID), which is not defined in the existing standards, in a MAC subheader.

When the notification is performed using the DCI, the notification may be performed by a specific field of the DCI, a radio network temporary identifier (RNTI) used for scrambling of cyclic redundancy check (CRC) bits assigned to the DCI, a format of the DCI, and the like.

The notification of any information to the UE in the above-described embodiments may be performed periodically, semi-persistently, or aperiodically.

{Notification of Information from UE}

Notification of any information from the UE (to the NW) (in other words, transmission/report of any information to the BS in the UE) in the above-described embodiments may be performed using physical layer signaling (e.g., UCI), higher layer signaling (e. g., RRC signaling, MAC CE), a specific signal/channel (e. g., a PUCCH, a PUSCH, a PRACH, or a reference signal), or a combination of these.

When the notification is performed using the MAC CE, the MAC CE may be identified by including a new LCID, which is not defined in the existing standards, in a MAC subheader.

When the notification is performed using the UCI, the notification may be transmitted using a PUCCH or a PUSCH.

The notification of any information from the UE in the above-described embodiments may be performed periodically, semi-persistently, or aperiodically.

### {About Application of Each Embodiments}

At least one of the above-described embodiments may be applied when a specific condition is satisfied. The specific condition may be defined in standards, or may be notified to the UE/BS using higher layer signaling/physical layer signaling.

At least one of the above-described embodiments may be employed only in the UE that has reported a specific UE capability or supports the specific UE capability.

The specific UE capability may indicate at least one of the following:
Support of specific processing/operation/control/information for at least one of the embodiments above

The specific UE capability may be capability applied to all frequencies (in common regardless of frequencies), capability for each of frequencies (for example, one or a combination of a cell, a band, a band combination, a BWP, a component carrier, and the like), capability for each of frequency ranges (for example, Frequency Range 1 (FR1), FR2,FR3,FR4,FR5,FR2-1,and FR2-2), capability for each subcarrier spacing (SCS), or capability for each feature set (FS) or feature set per component-carrier (FSPC).

The specific UE capability described above may be a capability applied across a full duplex mode (commonly regardless of duplex mode), or a capability per duplex mode (for example, time division duplex (TDD), frequency division duplex (FDD)).

At least one of the above-described embodiments may be applied when the UE is configured/activated/triggered with specific information related to the above-described embodiments (or with performing the actions of the above-described embodiments) by higher layer signaling/physical layer signaling. For example, the specific information may be any RRC parameter for a specific release (for example, Rel. 18/19).

In a case where the UE does not support at least one of the specific UE capabilities described above or is not configured with the specific information, the UE may apply, for example, Rel-15/16 operation.

### Supplementary Note

Regarding one embodiment of the present disclosure, the following supplementary notes of the invention will be given.

### {Supplementary Note 1}

A terminal including: a receiving section that receives information related to a type of a demodulation reference signal (DMRS) for a physical uplink shared channel (PUSCH); and a control section that controls to apply a specific DMRS type when dynamic waveform switching for the PUSCH is configured.

### {Supplementary Note 2}

The terminal according to supplementary note 1,wherein when a second DMRS type is configured as the DMRS type for the PUSCH and a single carrier waveform is applied to the PUSCH, the control section controls to apply a first DMRS type to the PUSCH to which the single carrier waveform is applied.

### {Supplementary Note 3}

The terminal according to supplementary note 1 or 2,wherein the control section determines whether or not the second DMRS type is applied, based on information of a waveform of the PUSCH indicated by downlink control information (DCI) used for scheduling of the PUSCH.

### {Supplementary Note 4}

The terminal according to any one of supplementary notes 1 to 3,wherein when a second DMRS type is configured as the DMRS type for the PUSCH, the control section performs at least one of determination of a bit width of a given field of downlink control information used for scheduling of the PUSCH and interpretation of the given field in consideration of a first DMRS type.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

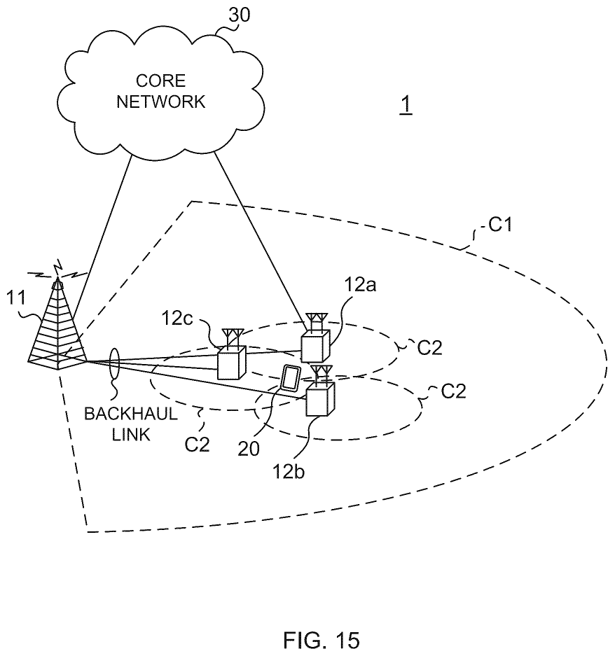

FIG. 15 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.” The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility Management Function (AMF), a Session Management Function (SMF), Unified Data Management (UDM), an Application Function (AF), a Data Network (DN), a Location Management Function (LMF), and operation, administration, and maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal) .”

### Base Station

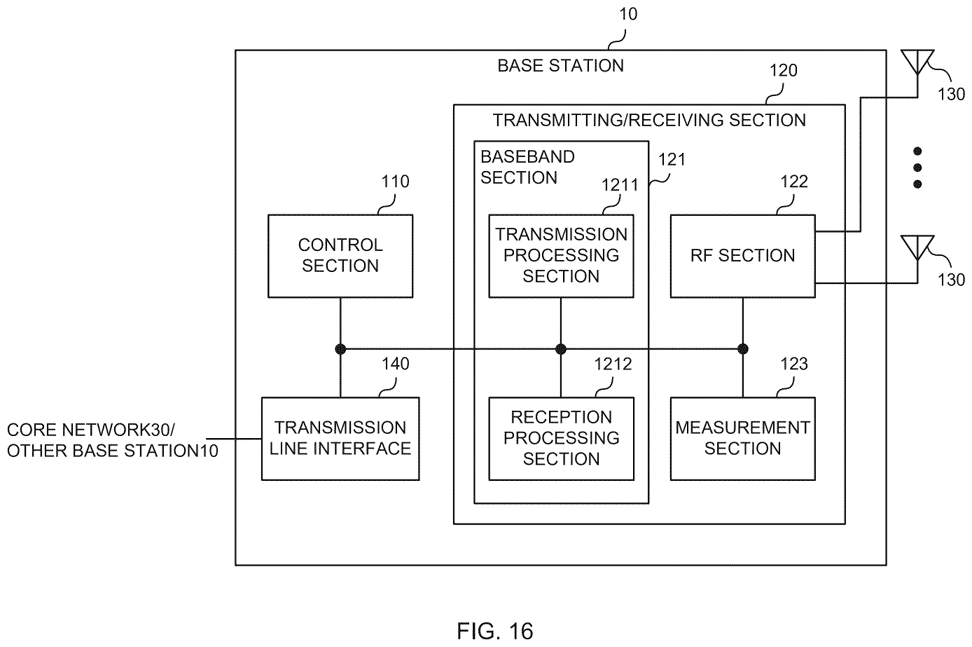

FIG. 16 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212.

The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section.

The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The Transmitting/receiving Section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus (for example, a network node providing NFs) included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may transmit information (for example, dmrs-Type) related to a type of a demodulation reference signal (DMRS) for a physical uplink shared channel (PUSCH).

The control section 110 may determine that a specific DMRS type is applied to the PUSCH (for example, a PUSCH to which a single-carrier waveform (for example, DFT-s-OFDM))/multi-carrier waveform (CP-OFDM)) is applied), when dynamic waveform switching for the PUSCH is configured.

### User Terminal

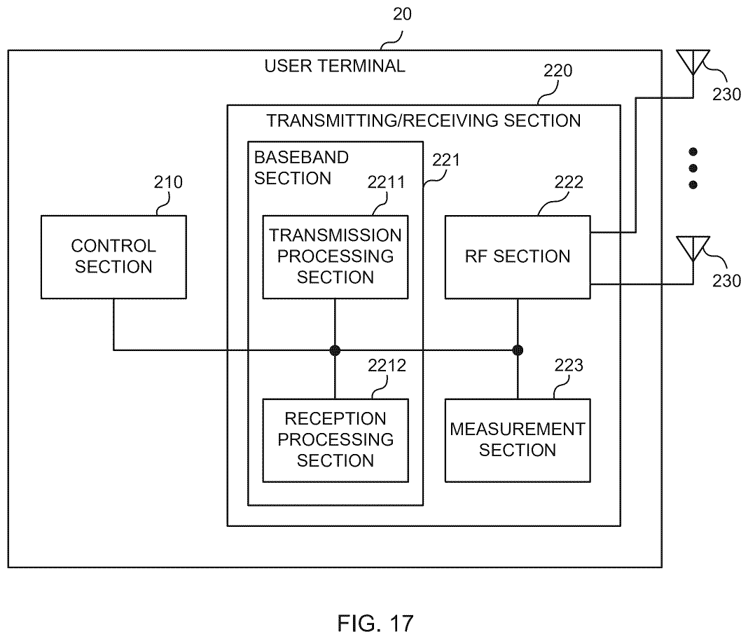

FIG. 17 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The Transmitting/receiving Antennas 230 Can Be Constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The Transmitting/receiving Section 220 (rf Section 222) May perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive information related to a type of a demodulation reference signal (DMRS) for a physical uplink shared channel (PUSCH).

The control section 210 may control to apply a specific DMRS type to the PUSCH to which a single-carrier waveform is applied, when dynamic waveform switching for the PUSCH is configured.

When a second DMRS type is configured as the DMRS type for the PUSCH and a single carrier waveform is applied to the PUSCH, the control section 210 may perform the control such that a first DMRS type is applied to the PUSCH (for example, (for example, a PUSCH to which a single-carrier waveform (for example, DFT-s-OFDM))/multi-carrier waveform (CP-OFDM)) is applied)).

The control section 210 may determine whether or not the second DMRS type is applied, based on information of a waveform of the PUSCH indicated by downlink control information (DCI) used for scheduling of the PUSCH.

When a second DMRS type is configured as the DMRS type for the PUSCH, the control section 210 may control to perform at least one of determination of a bit width of a given field of downlink control information used for scheduling of the PUSCH and interpretation of the given field in consideration of a first DMRS type.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

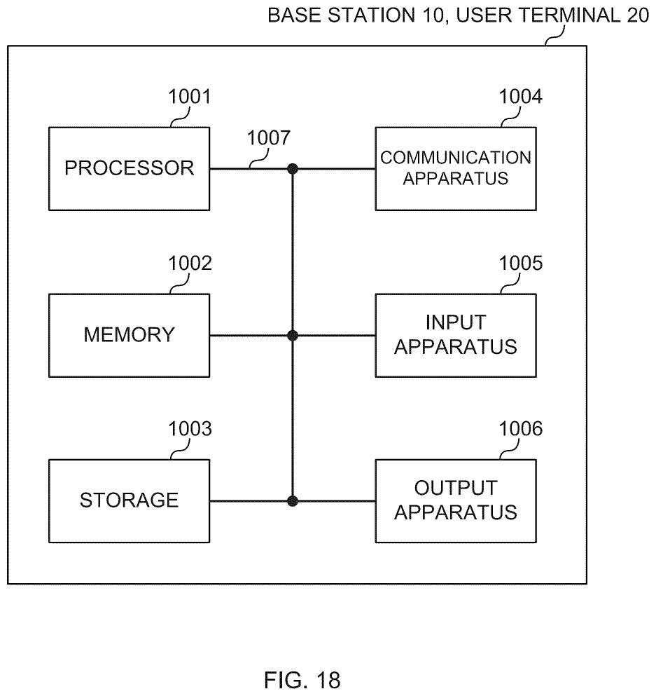

For example, a base station, a user terminal, and so on according to one embodiment of the present disclosure may function as a computer that executes the processes of the radio communication method of the present disclosure. FIG. 18 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media.. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies.

Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (RES). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CES).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal may be interpreted as a case that the base station indicates, for the terminal, control/operation based on the information, and vice versa.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

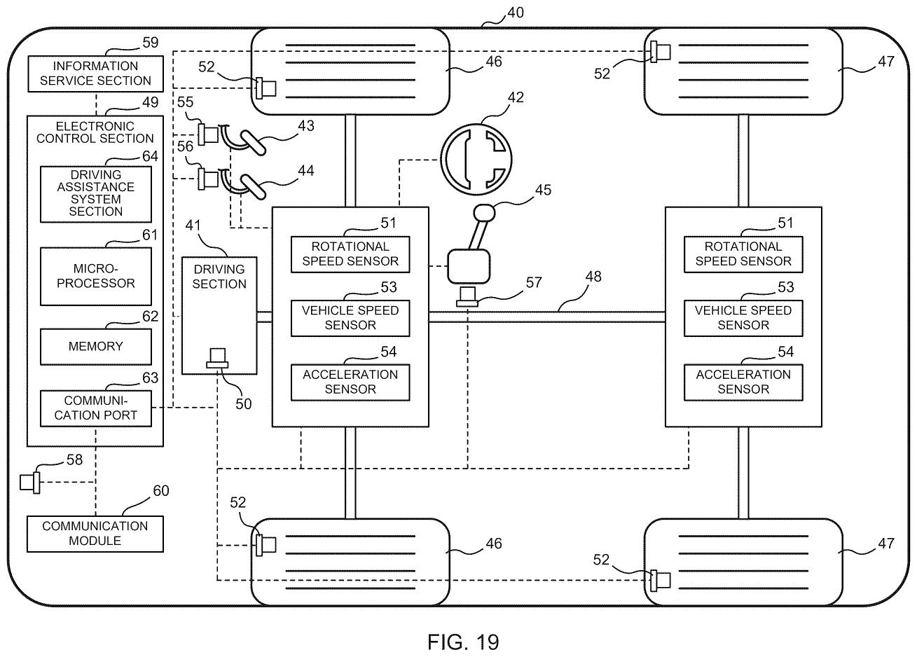

FIG. 19 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example,“sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of”and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition,“judging (determining)” as used herein may be interpreted to mean making “judgments (determinations)” about resolving, selecting, choosing, establishing, comparing, and so on. In other words,“judging (determining)” may be interpreted to mean making “judgments (determinations)” about some action.

In addition,“judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure,“equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example,“highest” may be interpreted as “i-th highest,” and vice versa).

In the present disclosure,“of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1-6. (canceled)

7. A terminal comprising:
a receiver that receives information regarding a demodulation reference signal (DMRS) type for a physical uplink shared channel (PUSCH); and
a processor that, when dynamic waveform switching for the PUSCH is configured, controls to apply a specific DMRS type.

8. The terminal according to claim 7, wherein the specific DMRS type is a first DMRS type.

9. The terminal according to claim 7, wherein when the dynamic waveform switching is configured, a configuration of a DMRS type other than the specific DMRS type is restricted.

10. A radio communication method for a terminal, comprising:
receiving information regarding a demodulation reference signal (DMRS) type for a physical uplink shared channel (PUSCH); and
when dynamic waveform switching for the PUSCH is configured, controlling to apply a specific DMRS type.

11. A base station comprising:
a transmitter that transmits information regarding a demodulation reference signal (DMRS) type for a physical uplink shared channel (PUSCH); and
a processor that, when dynamic waveform switching for the PUSCH is configured, determines that a specific DMRS type is applied to the PUSCH.

12. A system comprising a terminal and a base station, wherein the terminal comprises:
a receiver that receives information regarding a demodulation reference signal (DMRS) type for a physical uplink shared channel (PUSCH); and
a processor that, when dynamic waveform switching for the PUSCH is configured, controls to apply a specific DMRS type, and
the base station comprises:
a transmitter that transmits the information regarding the DMRS type; and
a processor that, when the dynamic waveform switching is configured, determines that the specific DMRS type is applied to the PUSCH.
